(19) United States
(12) Patent Application Publication
(10) Pub. No.: US 2010/0114345 A1
(43) Pub. Date: May 6, 2010

(54) METHOD AND SYSTEM OF CLASSIFICATION OF AUDIOVISUAL INFORMATION

(75) Inventors: David Conejer Olesti, Madrid (ES); Xavier Anguera Miro, Madrid (ES)

Correspondence Address: KNOBBE MARTENS OLSON & BEAR LLP, 2040 MAIN STREET, FOURTEENTH FLOOR, IRVINE, CA, 92614, US

(73) Assignee: TELEFONICA, S.A., Madrid (ES)

(21) Appl. No.: 12/610,597

(22) Filed: Nov. 2, 2009

Related U.S. Application Data
(60) Provisional application No. 61/110,891, filed on Nov. 3, 2008.

(51) Int. Cl. G06F 17/00; G06N 5/02; G06Q 30/00

(52) U.S. Cl. 700/94; 386/96; 706/54; 706/52; 705/14.4

(57) ABSTRACT

Method and system of classification of audiovisual information from a data stream by means of audio stream comparison. After detecting segments of the data stream containing advertisements, the segments are compared to a plurality of audio files stored in a database to cluster the detected advertisements. If the segment is not detected in the database it is included as a new audio file with its information in the database.

### CROSS-REFERENCE TO RELATED APPLICATIONS

This application claims priority under 35 U.S.C. §119 to U.S. Provisional Application No. 61/110,891, which was filed on Nov. 3, 2008, the disclosure of which is hereby incorporated by reference in its entirety.

### FIELD OF THE INVENTION

The present invention relates to multimedia processing and, in particular, to extracting information from broadcasted multimedia documents, for example TV, radio or Internet broadcasts.

### STATE OF THE ART

Currently, most of the methods of advertisements detection and clustering for monitoring purposes are performed by human professionals in a way that becomes tedious and time consuming.

Besides, to the inventors' knowledge, there does not exist any published system or method for performing both the detection and the clustering (detection of repetitions) for commercials.

In order to detect commercials on TV some efforts have been already made using either video or audio or audio plus video. When using video alone, a combination of rules identifying the dynamics of commercials insertion by the broadcasting companies and image features are used, for example searching for black frames or shot-cuts rate average Examples of such proposals can be found in A. G. Hauptmann, M. J. Witbrock, Story segmentation and detection of commercials in broadcast news video, in Proceedings ADL'98, Santa Barbara, USA, 1998; in R. Lienhart, C. Kuhmnch, W. Effelsberg, On the detection and recognition of television commercials, in Proc of IEEE Conference on Multimedia Computing and Systems, pages 509-516, Otawa, Canada, 1997; and in J. Sánchez, X. Binefa, Audicom: a video analysis system for auditing commercial broadcasts, in Proc. Of ICMCS'99, Firenze, Italy, 1999. However, these systems are usually computationally expensive and cannot achieve the performance of systems using audio features.

Other authors have proposed combined audio-visual methods. P. Duygulu et al., in Comparison and combination of two novel commercial detection methods, in Proc. ICME, Taiwan, 2004, exploit the repetition of commercials over time using video and refine the results using audio features, while M. Covell et al., in Advertisement detection and replacement using acoustic and visual repetition, in Proc. IEEE 8th Workshop on Multimedia Signal Processing, pp. 461-466, October 2006, analyze both audio and video features for repetitions. However, such approaches fail whenever non-commercial segments are repeated (for example in news programs).

In Automatic tv advertisement detection from mpeg bitstream, Journal of the Pattern Recognition Society, 35(12):2-15, 2002, D. A. Sadlier et al. use black video frames and audio energy together with a rule-based decision algorithm, with several fine-tuned thresholds. X.-S. Hua et al., in Robust learning-based tv commercial detection, in Proc. ICME, 2005, combine a set of visual and acoustic-based features with an SVM (Support Vector Machine) classifier for every detected video shot. In doing so they consider that all commercials contain common audio-video features that tell them different from regular content, which is not necessarily true in all cases.

Finally, Ling-Yu Duan et al., in Segmentation, Categorization, and identification of commercials from TV streams Using Multimodal Analysis, in Proc. ACM Multimedia 2006, Santa Barbara, USA, discusses about detection and multimodal classification of commercials, for which the use of intervals of silence between commercials is suggested. Advertisements are classified in general categories, without keeping track of the repetitions of each advert.

Therefore, there is a need to optimize and automatize the process of detection and clustering of advertisements in order to achieve sufficient performance. This would ease its processing and allow for many applications, especially in the broadcasting industry, such as monitoring how many times and when advertisements have been aired, eliminating certain advertisements when recording the content on their digital media centers, or being able to detect and substitute commercials targeted to the user's personal preferences.

### SUMMARY OF THE INVENTION

The present invention is intended to address the above mentioned need.

In a first aspect of the present invention there is provided a method of classification of audiovisual information which allows to detect and cluster advertisements on an audio stream, or on a video stream based on its associated audio stream.

The method starts by detecting in a data stream (which comprises both the video and audio stream or even an audio stream with no associated video) those segments which contain advertisements. In this document, the term data stream does not imply a broadcasting of the data, but rather any kind of codified video, whether it is stored or broadcasted. The detection of the aforementioned segments, each of which contains an unidentified advertisement, is preferably performed as follows (although any of the methods described in the prior art, or any other equivalent, may be used):
As advertisement breaks are usually isolated by a decrease in the audio signal, points in the data stream whose energy of the audio stream is a local minimum are first located.
Then, to confirm that the located points may correspond to the starting or ending of an advertisement, the audio stream at both sides (before and after) the located points are compared, checking if an acoustic change occurs at the located points. Preferably, this is checked by means of a Bayesian Criterion (BIC) Algorithm.
Preferably, the exact starting and ending instant of the audio decrease is detected (that is, the previous localization is refined to eliminate the random amount of silence usually inserted between commercials).

Finally, as advertisements usually have standard, defined lengths (5, 10, 15, 20 . . . seconds), the distances between two points with acoustic changes are computed and compared with a predefined set of lengths. If the computed distance is the same as one of the lengths of the set (allowing an error margin), the segment between said two points is considered to be an unidentified advertisement, and the rest of the method is performed as follows. The audio of the detected segments (that is, the segment of the audio stream which corresponds to the segment of the data stream which is detected as an advertisement) is then compared to a database of advertisements which stores the audio of said advertisements. If the comparison identifies a segment as being the same as one of the advertisements stored in the database, information about a new occurrence of the advertisement is stored (for example, the channel and time in which the advertisement is detected, or the number of times it is detected in a certain period of time). If the comparison does not recognize a segment as being an advertisement of the database, the audio of the segment is stored in the database, thus being used for further comparisons in order to also cluster advertisements which haven't been previously stored.

To compare a segment with the database, a distance between the audio of the segment and the audio of each of the stored advertisements is computed, understanding as distance a similarity measurement, lower distances meaning a higher similarity. Three different distances are proposed, although any alternative distance may be used within the scope of the invention:
1) Generalized Cross-Correlation (GCC): for each pair of signals (the audio of the segment and the audio of an advertisement), the maximum of the cross-correlation is found and normalized by the power of the signals. The bigger the correlation, the more similar the two signals are. In order to handle this measurement as a distance, the inverse of the cross-correlation is used.
2) Standard Dynamic Time Warping (DTW), in which frames are aligned using Mel-frequency cepstral coefficients (MFCC)
3) A modified Dynamic Time Warping, in which insertions and deletions are only allowed at the beginning and end of the signal pairs, taking thus advantage of the fact that if the advertisements are the same, the middle part of the signals are equal.

The computed distance is compared with a predefined threshold to determine whether the segment contains the same advertisement as the one to which the distance is computed. If the distance is lower than the threshold, then the segment is classified as containing the advertisement.

Preferably, the method also takes advantage of the performed clustering to refine the detection of segments, that is, if after a predefined period of time (typically of many hours or days), a segment is only detected once, said segment is considered as not being an advertisement.

In a further aspect of the present invention there is provided a device comprising means for carrying out the above-mentioned method.

Finally, the invention also refers to a computer program comprising computer program code means adapted to perform the steps of the above-mentioned method when said program is run on a computer, a digital signal processor, a field-programmable gate array, an application-specific integrated circuit, a micro-processor, a micro-controller, or any other form of programmable hardware.

The advantages of the proposed invention will become apparent in the description that follows.

### BRIEF DESCRIPTION OF THE DRAWINGS

To complete the description and in order to provide for a better understanding of the invention, a set of drawings is provided. Said drawings form an integral part of the description and illustrate a preferred embodiment of the invention, which should not be interpreted as restricting the scope of the invention, but rather as an example of how the invention can be embodied. The drawings comprise the following figures:

FIG. 1 shows a schematic representation of the modules of the system, and the information exchanged among them, according to a practical embodiment of the same.

### DESCRIPTION OF PREFERRED EMBODIMENTS OF THE INVENTION

In this text, the term “comprises” and its derivations (such as “comprising”, etc.) should not be understood in an excluding sense, that is, these terms should not be interpreted as excluding the possibility that what is described and defined may include further elements, steps, etc.

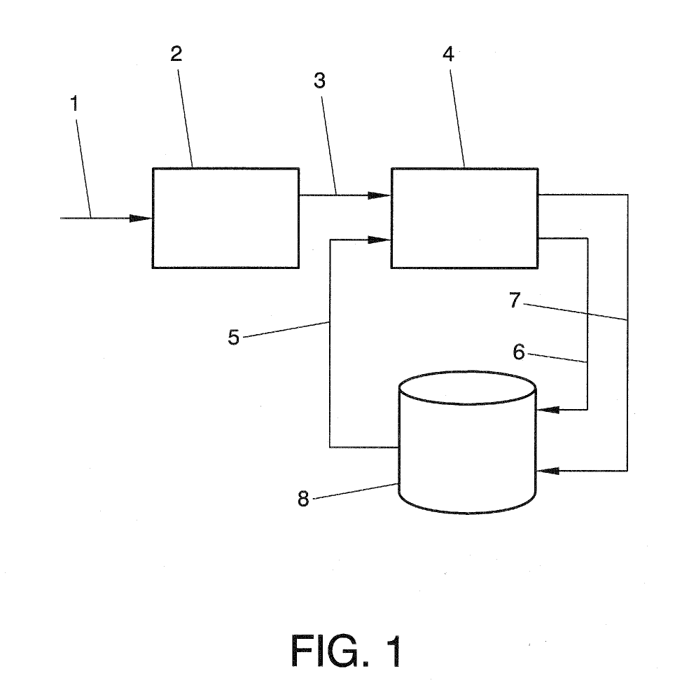

FIG. 1 shows a preferred embodiment of the system of the invention, in which detecting means 2 detect segments 3 of a data stream 1 which comprise advertisements, being these segments 3 then clustered by the comparison means 4 by looking for equivalences in the audio of advertisements stored in a database 8.

The first step of the method, which is detecting segments of the data stream which contain advertisements, can be performed according to any of the methods described in the prior art or any alternative method capable of performing the required segmentation.

As an example, an advertisement detection system is herein presented which is based exclusively on the analysis of the acoustic signal, thus having a better synergy with the second step of the method (advertisement clustering based on audio). The detection is based on two facts:
Advertisement breaks are usually isolated from actual programme material by a decrease in the audio signal occurring before and after each individual advertisement. Usually these silences last from 10 to 30 milliseconds and are digital nulls when advertising agencies and broadcasters use digital equipment. However, it is possible, and maybe quite probable, that these energy drops also occur during the valuable material of the programme itself.
Advertisements usually have standard, defined lengths, typically 5, 10, 15, 20 seconds . . . Although there are some exceptions, like TV channels selfpromotions, very long TVShop-like commercials, etc. In a study used to evaluate the performance of the method, using 14 hours 50 minutes of broadcasted data, the lengths of 10, 20 and 30 seconds correspond to more than 88% of the total number of advertisements.

In order to efficiently locate an advertisement, after extracting the acoustic signal and its MFCC parameters from the video file, a three-stage approach is used:
i) First the minimum energy points within the audio signal are found as hypothetical commercial start/end changes. In order to detect such change points, the energy average of the input signal is computed using a very narrow window. The narrowness of the window allows for detection of very low energy points while not triggering on false energy drops. A restrictive threshold is used to determine possible change points. Each energy minimum below the threshold is selected as a change point, and a mask around it is applied in order to avoid multiple triggers for the same advertisement.
ii) Then a validation of the points located in step i) is performed by checking if there is an acoustic change at each point by acoustically comparing both sides for each candidate using the Bayesian Information Criterion (BIC) Algorithm.
For each possible commercial change found in previous stages two hypothesis are modeled and compared. On the one hand H0 considers that both sides of the change point (Xa and Xb) share the same acoustic environment/belong to the same speaker. On the other hand H1 considers that both sides belong to different acoustic environments/speakers. Each hypothesis is modelled by Gaussian Mixture Models (GMM) following the BIC modification where H1 is modelled by a GMM per side (θ1a and θ1b), with eight Gauss. each, and H0 was modelled with 16 Gauss. (θ0) modelling the acoustic data in either side (H1) or both (H0). Modelled data is composed of MFC coefficients extracted from the acoustics with 26 coefficients and computed every 10 ms. BIC distance (ΔBIC) is computed as follows

ΔBIC(H₀, H₁)=BIC(H₀)−BIC(H₁)=L(Xₐ,X_{b}|θ₀)−L(Xₐ|θ₁a)−L(X_{b}|θ₁b)
According to the ΔBIC distance, all hypothesized change points with positive values are not considered anymore as possible commercial changes.
iii) After that, the proper selection of advertisements is made. To do so, first is necessary to find out precisely the boundaries of the connecting silences. This is done to eliminate the random amount of silence usually inserted between commercials. Afterwards, the distance between any two start-end marked points is compared with the set of allowed advertisement lengths, with a small error margin allowance. The resulting segments are considered to be commercials and are sent to the clustering step.

Once the segments with advertisements have been detected, they are compared with all the commercials of the same length (10″, 20″, 30″, on the database. If no commercial on the database is found to be equal to the new detected advertisement, this advertisement is included as a new one. In order to compare similarity between commercials three different methods are proposed: Standard Dynamic Time Warping (DTW), a simplified DTW (hereafter referred as DTWmod) algorithm and a Generalized Cross-Correlation (GCC) comparison between signals. Notice that similarity ratios can be equivalently used instead of distances, as they have the same approach but inverse value. If similarity ratios are used, the identification is considered positive when the distance between the audio stream and the advertisement is above a threshold.

For DTW and DTWmod. In order to improve the system performance, the region of possible frame to frame alignments in DTW is restricted by applying a global constraint composed by a Sakoe-Chiba band mask. The radius of said mask is preferably equal to the difference between the length of the segment detected and the length of the reference advertisement. This difference of length is consequence of allowing the aforementioned error margin.

Although DTW has extensively been used to find the optimum warp between two signals which are similar, in the regions where the two commercials are identical (i.e. everywhere except the initial-ending silence regions) such freedom to choose an appropriate warping is always reduced to the diagonal frame assignment. Therefore in this application a simplification of the DTW is used. On this modified DTW (DTWmod),

The DTWmod algorithm alignment is designed taking into account the restriction that when comparing two instances of the same advertisement the alignment selected for the central part will be always diagonal. According to this fact, the cost of all diagonal alignment paths with initial points {y, 0} for y=Ymax, Ymax−1 . . . 0 and initial points {0, x} for x=0, 1 . . . Xmax are computed and normalized by the corresponding frame length. As a design criterion, Ymax and Xmax are fixed to the length of the advertisements minus a certain amount of time, in order to allow not to take into account the complete firsts and lasts seconds of one or both advertisement instances.

The similarity measure SDTW computed by the DTW algorithm corresponds to the maximum value of the inverse cost of the diagonal paths, as seen on the following equation:

$${S}_{DTW} = 1 / min \{ {DTW}_{i} ( x , y ) , {DTW}_{j} ( x , y ) \}$$

$$with$$

$${DTW}_{i} ( x , y ) = \{ \begin{matrix}0 & x = {x}_{i} ; y = 0 \\ DTW ( \begin{matrix}x - 1 , \\ y - 1\end{matrix} ) + \frac{D ( x , y )}{{X}_{ma x} - {x}_{i}} & \begin{matrix}{x}_{i} < x \leq {X}_{ma x} ; \\ 0 < y \leq {Y}_{ma x} - {x}_{i}\end{matrix}\end{matrix} \\ and \\ {DTW}_{j} ( x , y ) = \{ \begin{matrix}0 & x = 0 ; y = {y}_{j} \\ DTW ( \begin{matrix}x - 1 , \\ y - 1\end{matrix} ) + \frac{D ( x , y )}{{Y}_{ma x} - {y}_{j}} & \begin{matrix}0 < x \leq {X}_{ma x} - {y}_{j} ; \\ {y}_{j} < y \leq {Y}_{m ax}\end{matrix}\end{matrix}$$

where D(x, y) are the distance between x^{th} and y^{th} MFCC components.

Finally, the third metric (GCC) corresponds to a standard cross-correlation implementation, which uses the inverse of the normalized maximum cross-correlation, normalized by the power of the signals being compared.

Experimental results for the described embodiment show best performances using DTWmod, reaching a clustering precision of 99.12% within a test database. The GCC alternative also shows a good performance, with a precision of 97.37%.

In conclusion, the invention enables to detect advertisements and to classify them, clustering different emissions of the same advertisement. As a consequence, a better and optimized supervision of advertisements in broadcasted television can be performed.

The invention is obviously not limited to the specific embodiments described herein, but also encompasses any variations that may be considered by any person skilled n the art (for example, as regards the choice of components, configuration, etc.), within the general scope of the invention as defined in the appended claims.

1. A method of classification of audiovisual information from a data stream which comprises at least an audio stream, wherein said method comprises:
detecting a plurality of segments of the data stream, wherein each segment is an undetermined advertisement candidate;
for each detected segment:
computing a distance between the audio stream of the detected segment, and each of a plurality of audio files stored in a database, each of the audio files containing audio of a determined advertisement;
if a computed distance is lower than a predefined threshold, including information in the database of a new occurrence of the advertisement to which said distance is computed.

2. The method of claim 1 wherein the method further comprises, for each detected segment:
if the lowest of the computed distances is greater or equal than the predefined threshold, storing in the database a new audio file comprising the audio stream of the detected segment and the associated information.

3. The method of claim 1 wherein the distance is an inverse of a maximum of a generalized crossed correlation.

4. The method of claim 1 wherein the distance is computed by means of Dinamic Time Warping using Mel-frequency cepstral coefficients of the detected segment and the audio files.

5. The method of claim 4 wherein the Dinamic Time Warping imposes an exact alignment between the detected segment and the audio files except at a predefined number of samples at the beginning of the detected segment and a predefined number of samples at the end of the detected segment.

6. The method of claim 1 wherein the method further comprises, if after a predefined amount of time, the database comprises information of only one occurrence of an advertisement, removing from the database the audio file containing audio of the advertisement and the information of the occurrence of the advertisement.

7. The method of claim 1 wherein the step of detecting a plurality of segments of the data stream further comprises:
locating points in the data stream whose energy of the audio stream is a local minimum;
checking if an acoustic change occurs at the located points;
if the distance between two points with acoustic changes and a length from a predefined set of lengths differ less than an error margin, detecting the segment between said two points.

8. The method of claim 7 wherein the step of detecting a plurality of segments of the data stream further comprises determining the boundaries of the points with acoustic changes before comparing the distance between two points and the lengths from the predefined set.

9. The method of claim 7 wherein the step of checking if an acoustic change occurs comprises using a Bayesian Information Criterion Algorithm.

10. A system of classification of audiovisual information from a data stream which comprises at least an audio stream, wherein the system comprises:
detecting means configured to detect a plurality of segments of the data stream, wherein each segment is an undetermined advertisement candidate;
wherein the system further comprises,
a data base which stores a plurality of audio files, each of the audio files containing audio of a determined advertisement and the associated information;
comparison means configured to, for each detected segment, compute a distance between the audio stream of the detected segment, and each of the plurality of audio files; and if a computed distance is lower than a predefined threshold, including information in the database of a new occurrence of the advertisement to which said distance is computed.

11. The system of claim 10 wherein the comparison means are also configured to, for each detected segment:
if the lowest of the computed distances is greater or equal than the predefined threshold, store in the database a new audio file comprising the audio stream of the detected segment and its information.

12. The system of claim 10 wherein the distance is an inverse of a generalized crossed correlation.

13. The system of claim 10 wherein the distance is computed by means of Dinamic Time Warping using Mel-frequency cepstral coefficients of the detected segment and the audio files.

14. The system of claim 10 wherein the method further comprises, if after a predefined amount of time, the database comprises information of only one occurrence of an advertisement, removing from the database the audio file containing audio of the advertisement and the information of the occurrence of the advertisement.

15. A computer program comprising computer program code means adapted to perform the steps of the method according to claim 1, when said program is run on a programmable electronic device selected from a group of: a general purpose processor, a digital signal processor, a field-programmable gate array, an application-specific integrated circuit, a micro-processor and a micro-controller.
